(19) United States
(12) Patent Application Publication
(10) Pub. No.: US 2017/0043443 A1
(43) Pub. Date: Feb. 16, 2017

(54) MANUFACTURING SYSTEM HAVING A PLURALITY OF MACHINE TOOLS AND METHOD FOR OPERATING A MANUFACTURING SYSTEM

(71) Applicant: MAG IAS GmbH, Eislingen (DE)

(72) Inventors: Hubert Bruder, Oberkirch (DE); Guido Jentzsch, Nordheim (DE)

(21) Appl. No.: 15/230,842

(22) Filed: Aug. 8, 2016

Related U.S. Application Data
(63) Continuation of application No. PCT/EP2015/052368, filed on Feb. 5, 2015.

(30) Foreign Application Priority Data
Feb. 14, 2014 (DE) 10 2014 101 874

(51) Int. Cl. B23Q 41/04; B23Q 41/02; B23Q 11/00; B23Q 41/06

(52) U.S. Cl. CPC B23Q 41/04; B23Q 41/06; B23Q 41/02; B23Q 11/0075; B23Q 2717/00

(57) ABSTRACT

A manufacturing system is proposed, said manufacturing system having a plurality of machine tools for performing chip-forming working operations on workpieces and comprising a plurality of work sequence devices, each of which comprises at least one machine tool, wherein the work sequence devices are sequentially arranged and different chip-forming workpiece working operations are performed in different work sequence devices, and comprising an automated transport device for transporting workpieces within and between work sequence devices, wherein at least one branch is provided in which a plurality of work sequence devices are arranged, wherein devices for non-chip forming workpiece treatment are arranged outside of the at least one branch.

This application is a continuation of international application No. PCT/EP2015/052368 filed on Feb. 5, 2015 and claims the benefit of German application No. 10 2014 101 874.5 filed on Feb. 14, 2014, which are incorporated herein by reference in their entirety and for all purposes.

### BACKGROUND OF THE INVENTION

The invention relates to a manufacturing system having a plurality of machine tools for performing chip-forming working operations on workpieces, said manufacturing system comprising a plurality of work sequence devices, each of which comprises at least one machine tool, wherein the work sequence devices are sequentially arranged and different chip-forming workpiece working operations are performed in different work sequence devices, and comprising an automated transport device for transporting workpieces within and between work sequence devices.

The invention further relates to a method for operating a manufacturing system.

Manufacturing systems (manufacturing plants) are used to carry out different working operations on a workpiece.

Exemplary of the items that are produced in a manufacturing system environment are cylinder heads and crankcases.

DE 10 2005 034 079 A1 discloses a modular manufacturing system using agent-based job assignment, said modular manufacturing system comprising workpiece working centers which are organized in working clusters. The workpiece working centers are linked together via a transport device having independent handling units. The assignment of workpieces and work sequences to individual workpiece working centers is automatically realized by a control device.

US 2011/0000082 A1 discloses a work line module comprising a plurality of machines, wherein the machines have a plurality of work-performing functions. In addition, non-work performing equipment, such as a monitoring machine, is provided.

DE 2 217 206 discloses a machine system in which machine tools, measurement stations and wash stations are associated with a conveyor device for workpiece carriers and wherein a controlling computer controls the system.

WO 2007/063374 A1 discloses a system comprising K machine lines, wherein K is a natural number. Each of the K machine lines comprises N machine tools for performing specific workpiece working operations, wherein N is a natural number greater than or equal to two.

### SUMMARY OF THE INVENTION

In accordance with an embodiment of the invention, a manufacturing system is provided that enables optimized operation.

In accordance with an embodiment of the invention, at least one branch is provided in which a plurality of work sequence devices are arranged, wherein devices for non-chip forming workpiece treatment are arranged outside of the at least one branch.

By the arrangement of a plurality of work sequence devices in a branch, the automated transport device can serve the corresponding machine tools in the at least one branch. As a result, space utilization is optimized. Transport distances can be kept short.

Examples of devices for non-chip forming workpiece treatment include for example checking devices, such as leak testing devices, cleaning devices, assembly devices and the like. By the arrangement outside of a branch, optimized operability of the machine tools of a branch is achieved and transport distances within a branch can be kept short. The footprint of the machine tools can be kept small. This in turn gives a simple way of providing enclosure of the machine tools in a branch in, for example, a climate chamber or tempering chamber. The footprint of the enclosure is minimized.

Furthermore, it provides a simple way for workpieces to be delivered to a central device, for example for checking purposes or measurement purposes, and the automated transport device can be utilized for transporting the workpieces.

Furthermore, central chip removal can be realized and central supply of media and removal of media can also be realized for a branch. This results in space-conserving construction of the manufacturing system.

It is particularly advantageous for machine tools to be arranged and oriented in a line in the at least one branch. By arranging machine tools such that they are aligned with one another in a line, optimized utilization of space is achieved. The automated transport device can be configured in a simple manner; to this end, it can comprise for example one or more transport belts in order to transport workpieces within work sequence devices and between work sequence devices. Central chip removal as well as central supply of media and removal of media can be realized in a simple manner.

It is further advantageous for the at least one branch to have an aisle associated with it. As a result, machine tools can be easily loaded and unloaded.

It is advantageous for a front side of a machine tool of the at least one branch to face towards the aisle. This permits loading and unloading operations to be carried out via that access.

In particular, arranged on the front side of the machine tool is or are one or more doors of the corresponding machine tool, wherein the one or more doors enable access to a work area of the corresponding machine tool. It is thereby possible to provide access to the work areas of the machine tools from the aisle.

It is further advantageous for the automated transport device to extend at least partially along the front side. This provides ease of loading and unloading at the front side. The transport device is, at least in a portion thereof, arranged at the front and in particular in front of the machine tools. The machine tools can then be loaded and unloaded at the front side through the top of the machines via, for example, gantries or gantry robots.

Rear sides of the machine tools face away from the aisle and, advantageously, chip removal is realized from the rear sides. This results in optimized utilization of space.

In particular, provision is made for a central chip removal device which, at least in a portion thereof, extends along the rear sides. It is thereby possible for one chip removal device to be used for multiple work sequence devices.

It is further advantageous for the at least one branch to have associated with it a media-carrying branch by which a plurality of machine tools in the at least one branch are capable of being supplied with one or more media and/or one or more media is or are capable of being removed from machine tools. This makes it possible, for example, for the coolant supply or lubricant supply to be centralized at least to a certain extent.

In an embodiment, the aisle is formed between a first branch and a second branch. This results in optimized utilization of space.

Advantageously, at least a portion of the transport device that runs along the at least one branch is configured as a transport belt. This provides a simple way of transporting workpieces over a long length.

It is further advantageous for at least a portion of the transport device that effects transport in a direction transverse to a longitudinal direction of the at least one branch to be configured in the form of a device capable of travelling on a floor of the aisle or in the form of a transporting device spaced at a height distance from the floor. This provides a simple way of bridging the aisle and also of keeping the aisle clear. A transporting device that is spaced at a height distance above the floor is configured for example as an overhead conveyor belt having lifts associated with it or is configured as a gripper which, for example, transfers workpieces across from one transport conveyor belt to a parallel transport conveyor belt. A travelling device capable of travelling on the floor of the aisle (shuttle) can be configured such that when not in use, the corresponding vehicle is in a park position that does not obstruct the aisle. As an example, the vehicle is configured as an electric vehicle and the floor has induction loops embedded therein.

In an exemplary embodiment, the at least one branch is enclosed in an enclosure. This makes it possible, for example, for a plurality of work sequence devices to be tempered. By the arrangement in a branch, optimized utilization of space is achieved and the area that then needs to be enclosed is minimized in terms of footprint.

As an example, the at least one branch is enclosed in a tempering chamber or climate chamber.

Advantageously, a control device is provided which controls the manufacturing system and by which the outward transfer of workpieces from a work sequence device to the central device by the automated transport device and/or the inward transfer of workpieces from the central device to a work sequence device is capable of being controlled. Automated outward transfer and/or automated inward transfer can thereby also be achieved.

It is advantageous for a central device to be provided which is connected to the automated transport device and to which workpieces are capable of being delivered from work sequence devices via the automated transport device.

Workpieces that have been worked upon in a work sequence device must, for example, be checked and/or measured. By way of example, workpieces are checked in a statistical process control environment. After a new tool is installed on a machine tool, it is appropriate to check or measure workpieces.

In the solution in accordance with the invention, workpieces can be transported from a work sequence device to the central device and, optionally, transported back. Thus, workpieces can be transferred out and brought to the central device. At the central device, workpieces from different work sequence devices can be locally and centrally checked or measured. In this way, the number of corresponding checking locations and measurement locations in the manufacturing system can be kept low because, for example, the need for each work sequence device to have its own checking location or measurement location is eliminated.

Furthermore, the automated transport device can be utilized for transport. As a result, the distances an operator has to travel to get a workpiece to a checking location or a measurement location are minimized. With the automated transport device, workpieces are provided in an automated manner to the central device, where the checking or measurement operations can be carried out.

It is then advantageous for workpieces to be capable of being delivered from the central device to work sequence devices via the automated transport device. This makes it possible, for example, for a workpiece to be transferred back into the production process after it has been checked at the central device and found to have successfully passed its quality control check.

In particular, workpieces are capable of being delivered to the central device from each work sequence device via the automated transport device and/or workpieces are capable of being delivered from the central device to each work sequence device via the automated transport device. This makes it possible, for example, for the entire quality control process for the manufacturing system to be performed at the central device.

It is advantageous for the central device to comprise at least one of the following: a checking location, a measurement location which comprises in particular at least one coordinate measuring machine, a workpiece setup device, a staff room, a console device for a control device of the manufacturing system, a tool setup device (tool setup location). The provision of a workpiece setup device (workpiece setup location) at which, for example, a workpiece can be combined with an adapter plate, provides the ability of realizing the corresponding operation and inward transfer at a central site. Furthermore, when a console device is provided at the central device, optimized accessibility is enabled. A staff room for operators at the central device optimizes the manufacturing system's footprint. At a tool setup device, an operator can, with suitable equipment, set up tools that are destined to be swapped in on machine tools.

It is advantageous for a cleaning device to be provided which is associated with the central device and at which workpieces are capable of being cleaned. By way of example, a workpiece should go through a cleaning process, for example by treatment with a blow of air, before it is checked. Also, a workpiece should be washed before it is measured on a coordinate measuring machine. By the provision of the central device, a small number of cleaning devices can be used to carry out the corresponding cleaning operations.

Transport to and from the cleaning device can be realized via the automated transport device.

In this arrangement, the cleaning device can be completely or partially located at the central device or it can be completely or partially spaced apart from the central device.

In an exemplary embodiment, the cleaning device is associated with a plurality of work sequence devices, wherein workpieces from different work sequence devices are capable of being delivered to the cleaning device via the automated transport device and in particular wherein workpieces from all work sequence devices are capable of being delivered to the cleaning device via the automated transport device. In this way, the number of individual components of the manufacturing system can be kept low.

Advantageously, the cleaning device comprises at least one air-based cleaner (dry cleaner). In particular, in an air-based cleaner, a workpiece is blown clean by use of blow air. The workpiece can then be checked as to its quality, for example.

It is further advantageous for the cleaning device to comprise, alternatively or in addition, at least one washer (wet cleaner). A washer allows a workpiece to be washed, in particular for rendering it fit for being measured on a coordinate measuring machine.

It is further advantageous for at least one transfer location to be provided from which workpieces are capable of being delivered to the central device via the automated transport device and which is spaced apart from the central device. It is thereby possible to achieve optimized outward and inward transfer.

In an exemplary embodiment, the at least one transfer location has associated with it a checking device by which workpieces are capable of being checked, in particular wherein a check is capable of being made as to whether or not a workpiece is to be excluded from the working process. For example, workpieces that are damaged (for example because a tool part has become stuck therein) can then be excluded. Such workpieces then need not be progressed through the stage of checking at the central device. Such a workpiece as has been identified by the checking device to be “not in order” can be routed to the central device and can then be directly removed there from the production process.

Advantageously, the at least one transfer location is arranged at a transition from one work sequence device to the next neighbouring work sequence device. As a result, optimized outward and inward transfer are achieved.

In particular, the at least one transfer location is arranged at the automated transport device. This creates a simple possibility of transport to the central device.

It is advantageous, when a work sequence device comprises a plurality of machine tools, to realize parallel working of workpieces in the corresponding work sequence device. This provides a way of achieving a high throughput of workpieces in the manufacturing system.

Workpiece working in the sequential work sequence devices is sequential, in particular wherein workpieces from one work sequence device are transferred to a next neighbouring work sequence device. Workpiece transport times can thereby be kept low.

In accordance with an embodiment of the invention, a method is provided in which work sequence devices are sequentially arranged in at least one branch and non-chip forming workpiece treatments are performed outside of the at least one branch.

The method in accordance with the invention is capable of being carried out on the manufacturing system constructed in accordance with the invention.

The advantages of the method in accordance with the invention have already been explained in the context of the manufacturing system constructed in accordance with the invention.

In particular, provision is made for transport for non-chip forming workpiece treatments to be realized in a direction transverse to the at least one branch. This makes for a space-conserving construction of the manufacturing system.

In an embodiment, workpieces are transferred out of a work sequence device and are transported to the central device in an automated manner by the automated transport device and/or workpieces are transported away from the central device and are transferred into a work sequence device in an automated manner by the automated transport device. It is thereby possible for central tasks, such as checking tasks or measurement tasks, to be performed at the central device. The automated transport device is used to bring workpieces to said central device and workpieces can be transferred back from the central device into work sequence devices. It is then possible, for example, for a testing location or a measurement location to be associated with a plurality of work sequence devices. Transport distances for an operator are minimized.

It is advantageous for a workpiece checking operation and/or a workpiece measuring operation to be performed at the central device. At the central device, workpieces from different work sequence devices can be checked or measured.

It is further advantageous for cleaning of workpieces to be carried out at a central cleaning device to which the workpieces are transported by the automated transport device and, in particular, from which workpieces are transported to the central device. Optimized checking and measurement can thereby be carried out at the central device. The number of cleaning devices can be kept low.

For example, workpieces are transferred out of work sequence devices in a statistical process control (SPC) environment. This is a simple way of providing quality control capability.

In an exemplary embodiment, outward transfer of workpieces is carried out when a machine tool is loaded that is arranged next to a transfer location. This results in cycle time optimization when loading is realized in accordance with a fixed sequence.

In an exemplary embodiment, provision is made for machine tools to be variably associated with work sequence devices. This provides a way of responding to different requirements and conditions during the production sequence. If, for example, one work sequence device “provides an insufficient number of workpieces” within the overall process, then said variability permits one or more machine tools of another work sequence device (and in particular of the neighbouring work sequence device) to be associated with the first-named work sequence device.

By way of example, neighbouring machine tools perform chip-forming workpiece working in a first work sequence device or in a second work sequence device, in particular wherein a control device sets which work sequence device is associated with a corresponding machine tool. It is then possible for the neighbouring machine tools to be associated with different work sequence devices or to be associated with the same work sequence device, as demanded by the production process.

For the same reason, it is advantageous for next neighbouring machine tools in different work sequence devices to be variably operated in terms of a work sequence. This results in a high flexibility of the manufacturing system.

The following description of preferred embodiments serves in conjunction with the drawings to explain the invention in greater detail.

### BRIEF DESCRIPTION OF THE DRAWINGS

FIG. 1 is a schematic representation of an exemplary embodiment of a manufacturing system constructed in accordance with the invention.

### DETAILED DESCRIPTION

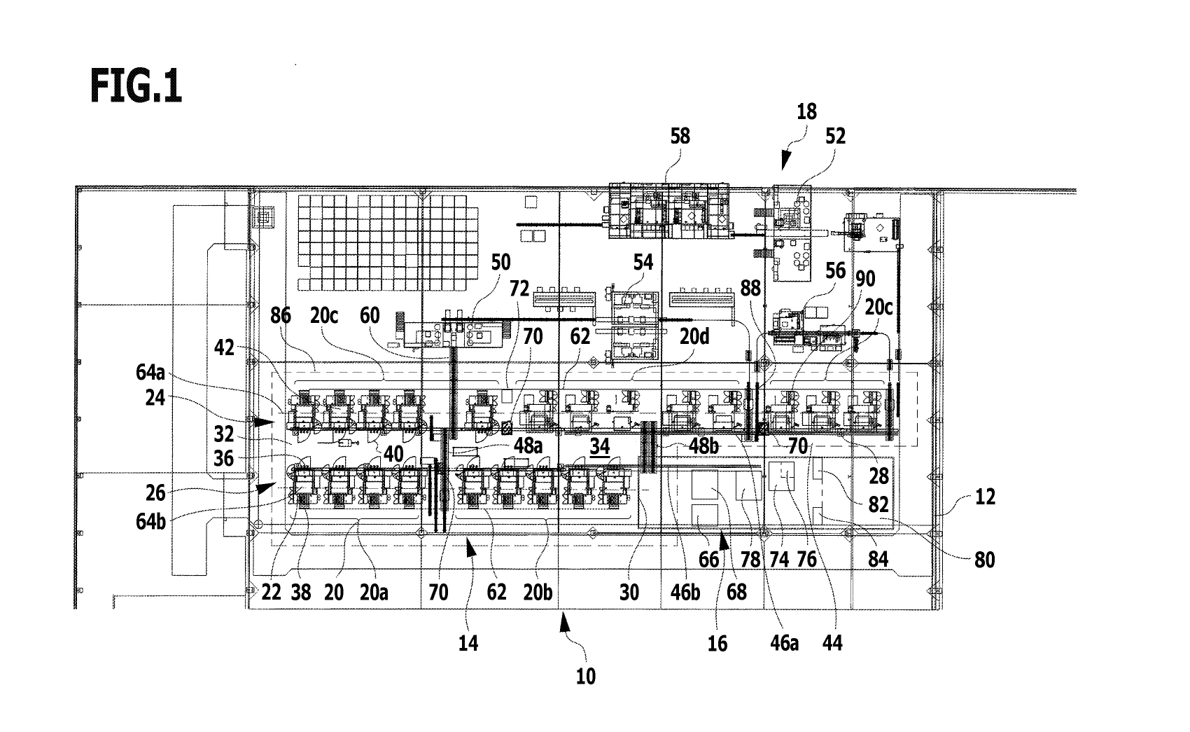

An exemplary embodiment of a manufacturing system constructed in accordance with the invention, shown in FIG. 1 and designed therein by 10, is for example arranged in a shop 12.

The manufacturing system 10 comprises a chip-forming machining device 14. Here, the chip-forming machining device 14 comprises a plurality of machine tools for performing work upon a workpiece by a chip-forming process.

Furthermore, the manufacturing system 10 comprises a central device 16. Furthermore, the manufacturing system 10 comprises a workpiece treating device 18, in particular in which non-chip forming workpiece treatment occurs.

The chip-forming machining device 14, the central device 16 and the workpiece treating device 18 are arranged in different parts of the shop 12.

The manufacturing system 10 comprises a plurality of work sequence devices 20. In the exemplary embodiment shown, the manufacturing system comprises a first work sequence device 20a, a second work sequence device 20b, a third work sequence device 20c, a fourth work sequence device 20d and a fifth work sequence device 20e.

Each work sequence device 20 comprises at least one machine tool 22 for performing chip-forming working operations upon a workpiece. In the exemplary embodiment shown in FIG. 1, each work sequence device 20 comprises a plurality of machine tools 22.

The machine tools 22 within a work sequence device 20 usually perform parallel working of workpieces, meaning that a plurality of workpieces are worked on by the different machine tools 22 of a work sequence device 20 in the same manner, wherein the workpiece working operations, which are chip-forming operations, are at least approximately synchronized.

Different types of machine tools 22 can be used in different work sequence devices 20, or machine tools 22 can be differently set in different work sequence devices (even if their configuration is the same).

In particular, the machine tools 22 perform chip-forming working operations on metal parts.

The work sequence devices 20 are sequentially arranged. A certain workpiece that is worked on at one work sequence device 20 is, at the completion of the working operation (and possibly an intermediate treatment), transferred to the next work sequence device, and a subsequent working operation is carried out there. In particular, different chip-forming workpiece working operations are carried out in different work sequence devices 20, in particular wherein these workpiece working operations build on one another with respect to the corresponding work sequence device 20, i.e. a certain sequence must be observed.

In the manufacturing system 10, work sequence devices 20 are arranged in a first branch 24 and in a second branch 26. In the exemplary embodiment shown, the first branch 24 comprises the work sequence devices 20c, 20d, 20e. The second branch 26 comprises the work sequence devices 20a and 20b.

The work sequence devices 20 and hence the machine tools 22 of the corresponding work sequence device 20 are arranged in the first branch 24 and second branch 26 one behind the other in a line 28 and 30 respectively. In particular, the machine tools 22 in the respective branch 24 or 26 are oriented such that they are at least approximately aligned with one another in a line.

An aisle 32 is arranged between the first branch 24 and the second branch 26 and hence between the machine tools 22 of the first branch 24 and those of the second branch 26. An operator can walk through or drive through said aisle.

The aisle 32 has a floor 34. Said floor 34 is for example the floor of the shop 12 or a floor 34 that is arranged on the floor of the shop 12.

The machine tools 22 each have a front side 36 and a rear side 38. The front sides 36 of the machine tools 22 face towards the aisle 32 and the rear sides 38 thereof face away from the aisle 32. Correspondingly, the front sides 36 of the machine tools 22 are accessible from the aisle 32.

Arranged on the front sides 36 of the machine tools 22 are one or more doors 40 via which a work area 42 of the corresponding machine tool 22 is made accessible.

The front sides 36 of the machine tools 22 of the first branch 24 face towards the front sides of the machine tools 22 of the second branch 26.

The manufacturing system 10 comprises an automated transport device 44. The automated transport device 44 serves the transport of workpieces in the manufacturing system, thereby serving the transport of workpieces within the chip-forming machining device 14 as well as the transport of workpieces from the chip-forming machining device 14 to the central device 16 and to the workpiece treating device 18. The automated transport device 44 has portions 46a, 46b. Said portions 46a, 46b extend along the first branch 24 (portion 46a) and second branch 26 (portion 46b), along the front sides 36 of the corresponding machine tools 22. Via the portions 46a, 46b, the machine tools 22 can be loaded or unloaded via the front sides 36 thereof.

To load and unload the machine tools 22, there are provided for example gantries or gantry robots. With these, the machine tools 22 are loaded from above at the respective front sides 36 thereof.

In particular, the portions 46a, 46b are formed by conveyor belts.

A transport direction in the portions 46a, 46b is in particular at least approximately parallel to the lines 28, 30 (wherein the lines 28, 30 are at least approximately parallel to one another).

In particular, transport directions in the portions 46a, 46b are parallel to each other.

The automated transport device 44 further comprises portions 48a, 48b which enable transport in a direction transverse to the lines 28, 30 and in particular enable a connection between the first branch 24 and the second branch 26 with respect to the automated transport device 44. By the provision of the portions 48a, 48b of the automated transport device 44, the aisle 32 can be bridged.

In an exemplary embodiment, a portion 48a is provided which is arranged between the first work sequence device 20a and the second work sequence device 20b and leads into the third work sequence device 20c.

In an exemplary embodiment, there is further provided a portion 48b which leads from the central device 16 to the portion 46a. Here, the portion 46b of the automated transport device 44 runs along the second branch 26 to the central device 16. The central device 16 thereby becomes a portion of the transport device 44.

In an exemplary embodiment, the portions 48a, 48b are configured such that workpieces are transported at a height distance from the floor 34 of the aisle 32 in order not to hinder continuity. To this end, for example, an overhead conveyor belt including a corresponding lift is provided at the portions 46a, 46b. It is also possible, for example, for a gripper to be used in order to transfer workpieces from the portion 46a to the portion 46b and vice versa.

In a further exemplary embodiment, a portion 48a or 48b is formed by a vehicle which travels on the floor 34. Said vehicle takes workpieces away from the portion 46a or 46b and brings them to the portion 46b or 46a respectively. The vehicle (shuttle) is for example operated via induction loops laid in the floor 34. During a non-transport phase, the vehicle can be positioned in a park position that does not block the aisle 32.

The workpiece treating device 18 is arranged outside of the branches 24, 26.

In an exemplary embodiment, the workpiece treating device 18 comprises cleaning devices 50, 52 by which workpieces are capable of being cleaned, and assembly devices 54, 56, 58. Workpiece assembly operations are carried out at said assembly devices. Positioned upstream of an assembly device (for example the assembly device 54) is a cleaning device (in this case the cleaning device 50) in order to enable a workpiece to be cleaned before assembly work is performed thereon. In particular, a cleaning device 50 is configured as an air-based cleaning device in which a cleaning operation is carried out by use of compressed air. The cleaning device 50 can also be configured as or comprise a washer.

The automated transport device 44 comprises portions 60 via which workpieces can be transported away from the portions 46a and 46b, in a direction transverse to the lines 28 and 30 respectively, and transferred to the workpiece treating device 18 and thence, optionally, back into the first branch 24 and/or the second branch 26.

As has already been mentioned above, non-chip forming workpiece treatment operations are performed outside of the branches 24 and 26.

The manufacturing system 10 comprises a chip removal device 62 which is at least in a portion thereof routed in the branches 24, 26, in particular along the lines 28 and 30 respectively. In particular, chip removal is realized from the rear sides 38 of the corresponding machine tools. The chip removal device 62 is then routed at least partially in spaced relation to the aisle 32. A chip removal device 62 can be configured such that it has connected thereto several machine tools 22 and in particular several work sequence devices 20. The chip removal device 62 can thus be centrally configured and serve a plurality of machine tools.

Furthermore, provision may be made for supply and removal of media at a branch 24 or 26 or at the branches 24 and 26 to be centrally realized. In particular, (at least) one media-carrying branch may be provided; FIG. 1 shows media-carrying branches indicated by the reference characters 64a and 64b by which one or more media such as cooling medium and lubricating medium can be supplied and removed to and from a plurality of machine tools 22 and in particular to and from a plurality of work sequence devices 20.

In an exemplary embodiment, the central device 16 is arranged in extension of the second branch 26, opposite the first branch 24. The aisle 32 is located between the central device 16 and the first branch 24.

Workpieces are capable of being delivered to the central device 16 via the automated transport device 44. Furthermore, workpieces are capable of being delivered from the central device 16 to the work sequence devices 20 via the automated transport device 44.

In an exemplary embodiment, the central device 16 has (at least) one checking location 66. An operator can perform checking operations on workpieces at said checking location.

In an exemplary embodiment, a cleaning device 68 is arranged upstream of the checking location. The cleaning device 68 is in particular an air-based cleaning device (dry cleaning device) at which workpieces are capable of being cleaned by air blasting before they reach the checking location 66. The cleaning device 68 is in particular connected to the automated transport device 44. Alternatively or in addition, the cleaning device 68 can be or comprise a wet cleaning device (washer).

The cleaning device 68 can be loaded/unloaded automatically or manually. For manual loading, a transfer location is provided which can be visited by the transport device 44.

Workpieces from each work sequence device 20 can be delivered to the checking location 66 via the automated transport device 44 in order to permit checking thereof. In particular, it is thereby possible for statistical process control to be carried out in order, for example, to permit worked workpieces from the individual work sequence devices 20 to be statistically checked. The corresponding workpieces, after being worked upon at a work sequence device 20, are transported to the central device 16 and are delivered to the checking location 66 via the automated transport device 44.

In particular, transfer locations 70 are provided which are located at the automated transport device 44. Workpieces that are positioned at such transfer locations 70 are then delivered to the central device 16 via the automated transport device 44.

Here, provision may be made for a transfer location 70 to have associated with it a checking device 72 that carries out certain checking operations already at the transfer location 70. By way of example, the workpiece is checked for the presence of tool parts thereon. Such a part can then be excluded from the processing chain and need not be progressed through further checking operations (“NIO part”). The checking device 72 can be arranged at a machine tool 22; by way of example, it detects the occurrence of tool breakage and “memorizes” which workpiece(s) is (are) being worked upon when tool breakage occurs.

Alternatively or in addition, provision may be made for the central device to have arranged thereat a measurement location 74 for workpieces. Said measurement location 74 comprises for example (at least) one coordinate measuring machine 76.

Positioned upstream of such a measurement location 74 is a cleaning device 78, in particular in the form of a washer (wet cleaning device), in order to be able to perform measurements on clean workpieces. In an embodiment, the cleaning device 78 is also used to clean workpieces before they are coupled into the checking location 66 (in which case the cleaning device 68 can be omitted).

The cleaning device 78 can be loaded/unloaded automatically or manually. For manual loading, a transfer location is provided which can be visited by the transport device 44.

In an exemplary embodiment, the central device 16 comprises a staff room 80 for operators.

Provision may be made for the central device 16 to have arranged thereat a console device 82 for a control device 84 of the manufacturing system 10. The control device 84 controls operation of the manufacturing system 10, including the individual machine tools 22 and the devices and machines of the workpiece treating device 18, as well as the automated transport device 44.

Via the console device 82, the manufacturing system 10 can be operated as a whole or in portions or processes can be changed.

Provision may also be made for the central device 16 to have arranged thereat a workpiece setup device (workpiece setup location) at which workpieces are capable of being set up, for example mounted to an adapter plate.

It is further possible for the central device 16 to have a tool setup device (tool setup location). At the tool setup device, an operator can set up tools with suitable equipment before these are swapped in on machine tools 22.

In an exemplary embodiment, the work sequence devices 20 in the first branch 24 and in the second branch 26 are enclosed in an enclosure (reference numeral 86 in FIG. 1). Via said enclosure 86, a climate chamber or tempering chamber can be created for the machine tools 22 for chip-forming workpiece working. The corresponding enclosure 86 has a footprint smaller than that of the shop 12. In principle, the workpiece treating device 18 need not be completely incorporated into the enclosure. Likewise, the central device 16 need not be incorporated into the enclosure.

The manufacturing system 10 can comprise one or more buffer stores 88 for workpieces which are connected to the automated transport device 44 and are in particular arranged in the first branch 24 and/or in the second branch 26. Via the one or more buffer stores 88, workpieces can be temporarily stored in order, for example, to compensate for differences in cycle times occurring at different work sequence devices 20.

The manufacturing system 10 constructed in accordance with the invention works as follows:

Workpieces are run through the individual work sequence devices 20 and are worked upon therein. In particular, parallel working of workpieces is realized within a work sequence device 20.

Transport of the workpieces within the corresponding work sequence device 20 and between work sequence devices 20 is by the automated transport device 44.

Non-chip forming workpiece treatment in the workpiece treating device 18 is realized outside of the work sequence devices 20 and outside of the branches 24 and 26.

The workpieces worked upon by chip-forming workpiece working operations are in particular metal workpieces. By way of example, the manufacturing system is used to produce cylinder heads or crankcases.

The workpieces that are to be checked are, after being worked upon in the corresponding work sequence device 20, positioned at the respective transfer location 70. Such positioning is realized automatically. The workpieces are then transferred out and transported to the central device 16 via the automated transport device 44. The workpieces are cleaned before they are checked or measured. Such cleaning can be performed at a cleaning device of the central device 16 or at a cleaning device of the workpiece treating device 18.

The checking and measurement means are centrally managed at the central device 16. All the workpieces from different work sequence devices 20 that are destined to be checked are directed to the central device 16 and delivered to the corresponding checking location 66 or measurement location 74. An operator who is accomplishing checking or measurement tasks can then completely perform these tasks at the central device 16. This makes for a space-conserving construction of the manufacturing system 10 in particular with respect to the work sequence devices 20 and provides a simple way of carrying out measurement and checking operations in particular. Furthermore, checking locations 66 and measurement locations 74 can be associated with a plurality of work sequence devices 20. The central device 16 is in a sense responsible for all work sequence devices 20. The—in any case provided-automated transport device 44 is also used to transport workpieces that are to be checked or measured away from the individual work sequence devices 20 and, thereby, to the central device 16. Upon completion of the checking or measurement operation, the workpieces can be delivered to the next work sequence device 20, again via the automated transport device 44.

In the solution in accordance with the invention, at least two work sequence devices 20 are arranged in a branch (24 and 26) in which machine tools of different work sequence devices 20 are in particular arranged and oriented in a line 28 and 30 respectively.

The constituent parts of the workpiece treating device 18 are arranged outside of said branches 24, 26. A separation in different sections is thereby effected, wherein one section contains the chip-forming machine tools 22 and the other section, external to the branches 24, 26, contains workpiece handling machines for performing workpiece handling operations which are non-chip forming operations.

For example, with this arrangement, when an enclosure of machine tools 22 is provided, then the corresponding floor space requirement can be minimized because the workpiece treating device 18 need not usually be enclosed in an enclosure (in a tempering chamber or climate chamber).

By the arrangement of the machine tools 22 in branches, an aisle 32 can be realized which enables access to a large number of machine tools 22. In the exemplary embodiment shown in FIG. 1, the aisle 32 enables all of the machine tools 22 that perform chip-forming workpiece working operations of the manufacturing system 10 to be accessed via the front sides 36 thereof. The aisle 32, which is in particular of linear orientation, in a sense represents an “aorta” of the manufacturing system 10.

By the branch formation of the work sequence devices 20, the machine tools 22 can be easily loaded and unloaded from the aisle 32. Chip removal can be realized from the rear sides 38 via the chip removal device 62. This provides a way of keeping the aisle 32 free of obstacles, with corresponding good access to the work areas 42 of the machine tools 22.

Furthermore, supply and removal of media can be realized in a simple manner.

“Through-transfer” of workpieces, in particular for the purposes of performing checking and measurement operations thereon, can be easily realized. The—in any case provided—automated transport device 44 can be utilized to provide workpieces in an automated manner (under the control of the control device 84) to the central device 16 for checking and measurement purposes.

In particular, outward transfer or through-transfer operations of workpieces can be accomplished in a cycle time-optimized manner. For example, if the machine tools 22 of a work sequence device 20 are loaded in accordance with a fixed sequence, then an outward transfer operation is advantageously provided at a time when the machine tool 22 that is next to the corresponding transfer location 70 is loaded.

For example, the manufacturing system is operated in such a way that a certain number of workpieces per work sequence device 20 are transferred to the central device 16 in a controlled manner (according to schedule). Furthermore, it is advantageous for a certain number of workpieces per spindle of the machine tools 22 to be transferred out. For example, when a new tool is used on a machine tool 22, then a certain number of parts are transferred out after the first operation thereof with the new tool. Damaged parts, in particular wherein the damage is capable of being detected by the checking device 72, are also transferred to the central device 16 and are discarded there.

The arrangement of machine tools of different work sequence devices 20 in a branch, such as the first branch 24, also results in an increased variability of the manufacturing system.

It is in principle possible for machine tools (for example a machine tool 90 of the work sequence device 20e in the context of the example illustrated in FIG. 1) to be variably used in different work sequence devices (for example also in the work sequence device 20d in the example illustrated), responsive to demand. The corresponding variability is provided by the arrangement of a plurality of work sequence devices 20 in a branch 24, 26.

By way of example, the work content per work sequence device 20 is defined such that conditions of production are satisfied and the run time per work sequence device 20 corresponds to an integer multiple of the number of spindles in the work sequence device. For example, associating the machine tool 90 with the work sequence device 20d or with the work sequence device 20e in a manner that is variable with respect to time results in optimizations, such as tool optimizations, in order to increase the run time before a tool change or to prevent the occurrence of a “bottleneck”. For example, when an increased demand exists within a work sequence device, then the machine tool 90 is variably used within that work sequence device.

This provides a way of achieving optimized utilization of the manufacturing system.

Optimized overall availability can be achieved by the use of buffer stores 88.

### REFERENCE SYMBOL LIST

10 manufacturing system
12 shop
14 chip-forming machining device
16 central device
18 workpiece treating device
20 work sequence device
20a first work sequence device
20b second work sequence device
20c third work sequence device
20d fourth work sequence device
20e fifth work sequence device
22 machine tool
24 first branch
26 second branch
28 line
30 line
32 aisle
34 floor
36 front side
38 rear side
40 door
42 work area
44 automated transport device
46a portion
46b portion
48a portion
48b portion
50 cleaning device
52 cleaning device
54 assembly device
56 assembly device
58 assembly device
60 portion
62 chip removal device
64a media-carrying device
64b media-carrying device
66 checking location
68 cleaning device
70 transfer location
72 checking device
74 measurement location
76 coordinate measuring machine
78 cleaning device
80 staff room
82 console device
84 control device
86 enclosure
88 buffer store
90 machine tool

What is claimed is:

1. Manufacturing system having a plurality of machine tools for performing chip-forming working operations on workpieces, said manufacturing system comprising:
a plurality of work sequence devices, each of which comprises at least one machine tool, wherein the work sequence devices are sequentially arranged and different chip-forming workpiece working operations are performed in different work sequence devices; and
an automated transport device for transporting workpieces within and between work sequence devices;
wherein at least one branch is provided in which a plurality of work sequence devices are arranged, wherein devices for non-chip forming workpiece treatment are arranged outside of the at least one branch.

2. Manufacturing system in accordance with claim 1, wherein machine tools are arranged and oriented in a line in the at least one branch.

3. Manufacturing system in accordance with claim 1, wherein the at least one branch has an aisle associated with it.

4. Manufacturing system in accordance with claim 3, wherein a front side of machine tools of the at least one branch faces towards the aisle.

5. Manufacturing system in accordance with claim 4, wherein arranged on the front side of the machine tools is or are one or more doors of the corresponding machine tool, wherein the one or more doors enable access to a work area of the corresponding machine tool.

6. Manufacturing system in accordance with claim 4, wherein the transport device extends at least partially along the front side.

7. Manufacturing system in accordance with claim 3, wherein rear sides of the machine tools face away from the aisle and chip removal is from the rear sides.

8. Manufacturing system in accordance with claim 7, wherein a central chip removal device is provided which, at least in a portion thereof, extends along the rear sides.

9. Manufacturing system in accordance with claim 1, wherein the at least one branch has associated with it a media-carrying branch by which at least one of (i) a plurality of machine tools in the at least one branch are suppliable with one or more media and (ii) one or more media is or are removable from machine tools.

10. Manufacturing system in accordance with claim 3, wherein the aisle is formed between a first branch and a second branch.

11. Manufacturing system in accordance with claim 3, wherein at least a portion of the transport device that runs along the at least one branch is configured as a transport belt.

12. Manufacturing system in accordance with claim 3, wherein at least a portion of the transport device that effects transport in a direction transverse to a longitudinal direction of the at least one branch is configured in the form of a device capable of travelling on a floor of the aisle or in the form of a transporting device spaced at a height distance from the floor.

13. Manufacturing system in accordance with claim 3, wherein the at least one branch is enclosed in an enclosure.

14. Manufacturing system in accordance with claim 13, wherein the at least one branch is enclosed in a tempering chamber or climate chamber.

15. Manufacturing system in accordance with claim 1, wherein a control device is provided which controls the manufacturing system and by which at least one of (i) the outward transfer of workpieces from a work sequence device to the central device by the automated transport device is controllable and (ii) the inward transfer of workpieces from the central device to a work sequence device is controllable.

16. Manufacturing system in accordance with claim 1, wherein a central device is provided which is connected to the automated transport device and to which workpieces are deliverable from work sequence devices via the automated transport device.

17. Manufacturing system in accordance with claim 16, wherein workpieces are deliverable from the central device to work sequence devices via the automated transport device.

18. Manufacturing system in accordance with claim 16, wherein at least one of (i) workpieces are deliverable to the central device from each work sequence device via the automated transport device and (ii) workpieces are deliverable from the central device to each work sequence device via the automated transport device.

19. Manufacturing system in accordance with claim 16, wherein the central device comprises at least one of the following locations: a checking location, a measurement location, a workpiece setup device, a staff room, a console device for a control device of the manufacturing system, a tool setup device.

20. Manufacturing system in accordance with claim 16, wherein a cleaning device is provided which is associated with the central device and at which workpieces are cleanable.

21. Manufacturing system in accordance with claim 20, wherein the cleaning device is completely or partially located at the central device or is completely or partially spaced apart from the central device.

22. Manufacturing system in accordance with claim 20, wherein the cleaning device is associated with a plurality of work sequence devices, wherein workpieces from different work sequence devices are deliverable to the cleaning device via the automated transport device.

23. Manufacturing system in accordance with claim 20, wherein the cleaning device comprises at least one air-based cleaner.

24. Manufacturing system in accordance with claim 22, wherein the cleaning device comprises at least one washer.

25. Manufacturing system in accordance with claim 16, wherein at least one transfer location is provided from which workpieces are deliverable to the central device via the automated transport device and which is spaced apart from the central device.

26. Manufacturing system in accordance with claim 25, wherein the at least one transfer location has associated with it a checking device by which workpieces are checkable.

27. Manufacturing system in accordance with claim 25, wherein the at least one transfer location is arranged at a transition from one work sequence device to the next neighbouring work sequence device.

28. Manufacturing system in accordance with claim 25, wherein the at least one transfer location is arranged at the automated transport device.

29. Manufacturing system in accordance with claim 16, wherein, when a work sequence device comprises a plurality of machine tools, parallel working of workpieces is realized within the corresponding work sequence device.

30. Manufacturing system in accordance with claim 16, wherein workpiece working in the sequential work sequence devices is sequential.

31. Method for operating a manufacturing system having a plurality of machine tools for performing chip-forming working operations on workpieces, said manufacturing system comprising:
a plurality of work sequence devices, each of which comprises at least one machine tool, wherein the work sequence devices are sequentially arranged and different chip-forming workpiece working operations are performed in different work sequence devices; and
an automated transport device for transporting workpieces within and between work sequence devices;
wherein at least one branch is provided in which a plurality of work sequence devices are arranged, wherein devices for non-chip forming workpiece treatment are arranged outside of the at least one branch;
said method comprising:
sequentially arranging work sequence devices in at least one branch and performing non-chip forming workpiece treatments outside of the at least one branch.

32. Method in accordance with claim 31, wherein transport for non-chip forming workpiece treatments is realized in a direction transverse to the at least one branch.

33. Method in accordance with claim 31, performing at least one of (i) transferring workpieces out of a work sequence device and transporting them to the central device in an automated manner by the automated transport device and (ii) transporting workpieces away from the central device and transferring them into a work sequence device in an automated manner by the automated transport device.

34. Method in accordance with claim 33, performing at least one of a workpiece checking operation and a workpiece measuring operation at the central device.

35. Method in accordance with claim 33, wherein cleaning of workpieces is carried out at a central cleaning device to which the workpieces are transported by the automated transport device.

36. Method in accordance with claim 33, wherein workpieces are transferred out of work sequence devices in a statistical process control environment.

37. Method in accordance with claim 33, wherein outward transfer of workpieces is carried out when a machine tool is loaded that is arranged next to a transfer location.

38. Method in accordance with claim 31, wherein machine tools are variably associated with work sequence devices.

39. Method in accordance with claim 38, wherein neighbouring machine tools perform chip-forming workpiece working in a first work sequence device or in a second work sequence device.

40. Method in accordance with claim 38, wherein next neighbouring machine tools in different work sequence devices are variably operated in terms of a work sequence.
